(19) United States
(12) Patent Application Publication
(10) Pub. No.: US 2008/0206439 A1
(43) Pub. Date: Aug. 28, 2008

(54) Process for the Production of Lupin Extracts

(75) Inventors: Sarbjeet Kaur, New South Wales (AU); Catherine Gall Fryirs, New South Wales (AU); Ray Neale, New South Wales (AU)

Correspondence Address: SUGHRUE MION, PLLC, 2100 PENNSYLVANIA AVENUE, N.W., SUITE 800, WASHINGTON, DC, 20037, US

(73) Assignee: GEORGE WESTON FOODS LIMITED, New South Wales (AU)

(21) Appl. No.: 10/562,732

(22) PCT Filed: Jul. 1, 2004
(86) PCT No.: PCT/AU2004/000877

§ 371 Date: Apr. 18, 2008

Related U.S. Application Data
(63) Continuation-in-part of application No. 10/609,498, filed on Jul. 1, 2003, now abandoned.

(30) Foreign Application Priority Data
Jul. 1, 2003 (AU) 2003903332

(51) Int. Cl. A23J 3/14; A23J 1/14; A23L 1/29; C09D 101/02; A23L 1/20

(52) U.S. Cl. 426/648; 426/656; 106/163.01

(57) ABSTRACT

Process for the production of lupin extracts from lupins, comprising: (a) extracting lupin meal or flour with water at alkaline pH; (a) separating an alkali soluble lupin protein containing component from an alkali insoluble fibrous component; (b) adjusting the pH of the protein component with acid to a pH between 3-5.0 to precipitate a food grade lupin protein extract (PF1), from an acid soluble lupin protein containing component, collecting said precipitated food grade lupin protein extract (PF1), adjusting the pH of the extract to pH 5-6.5 and thereafter drying the extract to give a proteinaceous extract (PF1); and optionally, (c) dehydrating the acid soluble lupin protein containing component to give a second food grade lupin protein extract (PF3); or (e) raising the pH of the acid soluble lupin protein component to pH 5.7, and optionally recovering a lupin protein isolate (PF2), followed by dehydrating the soluble lupin protein component to give a third food grade lupin protein fraction (PF3). Further, there is described a lupin hydrocolloid fraction and a lupin fibre fraction.

### FIELD OF THE INVENTION

This invention relates to processes for the production of food grade lupin proteins, particularly lupin protein extracts, and use of lupin protein in foods and other applications. Lupin fibre may also be prepared in accordance with the invention, and products obtained therefrom.

### BACKGROUND OF THE INVENTION

Lupins are members of the pea family and their composition comprises proteins, fibre, oil and carbohydrate. More than 500,000 tonnes a year of lupins are produced in Australia and they provide a relatively cheap source of these useful raw materials.

The proteins and fibre components of lupin possess properties that make them potentially useful as food additives and stock feed ingredients. However, these components have had limited use in the past due to problems with intense colouration and off flavours which adversely affected the foods to which they were added. Thus, although large amounts of lupins are produced the material is primarily used in animal feed or simply “ploughed” back into the ground as a nutrient. Thus lupins are present as an under utilised resource.

A number of processes for lupin extraction have been proposed but they generally fail to meet the flavour and colour profiles required for extracted plant components, for use in food. Such processes may also be cumbersome to implement, and generally inefficient. For example, Australian Patent Application AU 199676195 describes an extraction process for lupins where a water slurry of lupin meal or flour is first subjected to acid extraction, then an alkaline second extraction, and finally to a countercurrent washing method to produce both a fibre fortified plant product and a protein milk product. This process uses large amounts of water, creates large amounts of salt water waste, and no benefits of colour improvement or flavour profile are described.

U.S. Pat. No. 6,335,044 B1, describes a method for treating and processing lupin seeds by means of crushing and shaping the seeds into platelet-shaped flakes, heating and de-oiling the flakes, followed by disembitterment using an aqueous process. Again colour problems are not addressed. Questions concerning the microbiological stability of such products also arise. Functionality of the extracted protein may also be affected.

The major component of the carbohydrates present in lupins is galactose. No previous processes of lupin extraction has provided for lupin fibre recovery, and subsequent use, for example the extraction of soluble hydrocolloids and/or galactose and recovery of galactose.

### SUMMARY OF THE INVENTION

In its broadest aspect, this invention is concerned with the processing of lupins, such as lupin flour or meal to produce lupin protein and optionally lupin fibre having high functionality and possessing a light colour, a bland non-bitter taste and low microbiological load, which may, for example, be referred to as food grade lupin protein or lupin extract such as a lupin fibre extract. The novel process in accordance with an aspect of this invention also shows improvements in yield and water usage over other described extraction methods.

The lupin protein extracts derived from the process can be used in a range of food and other applications, a number of which are described hereafter.

In accordance with a first aspect of this invention there is provided a process for the production of lupin extracts from lupins, comprising:
(a) extracting lupin meal or flour with water at alkaline pH;
(b) separating an alkali soluble lupin protein containing component from an alkali insoluble fibrous component;
(c) adjusting the pH of the protein component with acid to a pH between 3-5.0 to precipitate a food grade lupin protein extract (PF1), from an acid soluble lupin protein containing component, collecting said precipitated food grade lupin protein extract (PF1), adjusting the pH of the extract to pH 5-6.5 and thereafter drying the extract to give a proteinaceous extract (PF1); and optionally,
(d) dehydrating the acid soluble lupin protein containing component to give a second food grade lupin protein extract (PF3); or
(e) raising the pH of the acid soluble lupin protein component to pH 5-7, and optionally recovering a lupin protein isolate (PF2), followed by dehydrating the soluble lupin protein component to give a third food grade lupin protein fraction (PF3).

Lupin protein extract PF1 and lupin protein extract PF2 or PF3 are preferably recovered by the process in accordance with this aspect of the invention. These lupin protein extracts may be combined for subsequent use, or used individually in a variety of applications as hereinafter described. Preferably the lupin protein isolate is also recovered.

In another aspect this invention relates to lupin protein produced according to a process in accordance with the process aspect of this invention. Preferably the lupin protein is selected from one or more of lupin protein extract PF1, PF2 and/or PF3.

In another aspect of this invention there is provided a food product containing a food grade lupin protein, for example as a replacement for dairy, egg, soy or meat protein. Preferably the lupin protein is selected from one or more of lupin protein extracts PF1, PF2 and/or PF3. Preferred applications include as dairy replacers in powders (eg non dairy coffee whitener or creamer), in hot and/or cold beverages and/or food ingredients for soups, sauces, pastas, ice creams and other dairy/food products, as an egg white replacer in applications such as desserts, fish, meat and bakery products, and as a whole egg replacement in baking applications.

In another aspect of this invention there is provided a nutritional supplement containing a food grade lupin protein. Preferably the food grade lupin protein is selected from lupin protein extracts PF1, PF2 and/or PF3.

In another aspect of this invention there is provided a paper coating composition containing a lupin protein. Preferably the lupin protein is one or more of lupin protein extracts PF1, PF2 and/or PF3.

In another aspect of this invention there is provided a feed ingredient containing a lupin protein fraction for aquaculture and animal feed. Preferably the lupin protein is one or more of lupin extracts PF1, PF2 and/or PF3.

The fibrous component produced in accordance with the process embodiment of this invention is preferably recovered according to a further embodiment of this invention. The fibrous component may be treated with peroxide or washed in organic solvent to produce an off-white fibre. This fibre may be used as a unique source of fibre, or further processed to produce soluble hydrocolloids, or processed with acid and/or enzymes such as galactosidases to recover the galactose.

In a further aspect the invention provides a method of treating the fibre extracted from the lupin extraction processes described above to provide hydrocolloid (referred to as SHF1) suitable for use in food products, and a new fibre fraction (FF1).

In another aspect of the invention there is provided a soluble hydrocolloid fraction (SHF1) and a fibre fraction (FF1).

The hydrocolloid (SHF1) is preferably produced by mixing the fibre with water at pH 1-3, heating for 1 to 5 hows at a temperature from 60° C.-80° C., separating an insoluble precipitate (FF1) from a hydrocolloid (SHF1) and drying the hydrocolloid (SHF1).

The SHF1 has a smooth texture, a low viscosity, nutrient value and imparts body and desirable mouthfeel, which makes it suitable for use in: flavours; hot and cold beverages, such as sports beverages, beverages for paediatric and clinical nutrition; and/or food ingredients for soups; dairy products; sauces such as mayonnaise; pastas; desserts; ice creams and other dairy/food products. SHF1 may be used in foods etc in an amount from 05-8% w/w, such as 3-5% w/w. SHF1 has a neutral taste and an off white colour.

The new fibre fraction (FF1) has reduced water-binding properties and binds water in the ratio of 2 parts water to 1 part fibre. This renders the fraction particularly suitable for use in bakery products, which may remain fresher for longer where this fibre is used. This neutral-tasting nutritional fibre can also be used in a variety of other food products such as cereals and meat products. In addition the fibre is off white in colour and needs no further processing to improve colour.

### DESCRIPTION OF THE PREFERRED EMBODIMENTS

Surprisingly, it has been found that protein and optionally fibre can be extracted from lupins, particularly lupin flour and/or meal, with colour and flavour removed while retaining functional properties of the protein and fibre. In addition, the process gives high yield and minimal waste, low microbiological load, and high purity.

In its broadest aspect this invention is concerned with the processing of lupins, such as lupin flour or meal to produce lupin protein and optionally lupin fibre having high functionality and possessing a light colour, a bland non-bitter taste and low microbiological load, which may, for example, be referred to as food grade lupin protein.

In accordance with a first aspect of this invention there is provided a process for the production of lupin extracts from lupins, comprising:
(a) extracting lupin meal or flour with water at alkaline pH;
(b) separating an alkali soluble lupin protein containing component from an alkali insoluble fibrous component;
(c) adjusting the pH of the protein component with acid to a pH between 3-5.0 to precipitate a food grade lupin protein extract (PF1), from an acid soluble lupin protein containing component, collecting said precipitated food grade lupin protein extract (PF1), adjusting the pH of the extract to pH 5-6.5 and thereafter drying the extract to give a proteinaceous extract (PF1); and optionally,
(d) dehydrating the acid soluble lupin protein containing component to give a second food grade lupin protein extract (PF3); or
(e) raising the pH of the acid soluble lupin protein component to pH 5-7, and optionally recovering a lupin protein isolate (PF2), followed by dehydrating the soluble lupin protein component to give a third food grade lupin protein fraction (PF3).

Lupin protein extracts may also be referred to as lupin protein fractions or lupin protein. The extracts are generally mixtures of lupin protein having particularly advantageous properties as herein described. The extracts may also contain some fats and carbohydrates as hereafter described.

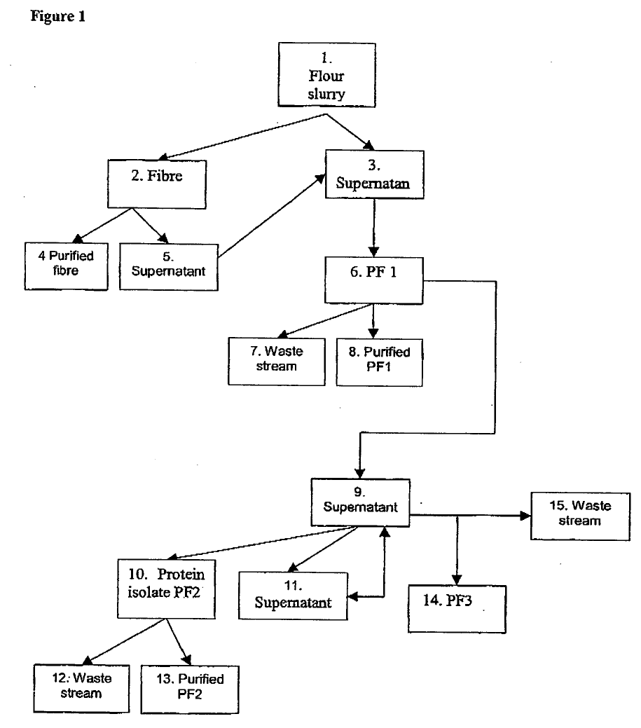

A detailed schematic diagram of the process embodiment of this invention is shown in FIG. 1 with reference numbers for each step in the process included for ease of description.

Lupin flour and/or meal may be prepared by standard procedures, such as crushing or comminuting and/or grinding or milling lupin plants and/or seeds, which may, or may not be, dehulled. By way of example only, a flour having particle sizes from about 50 to about 800 micrometres may be prepared. Lupin meal may be prepared by crushing the lupin plants and/or seeds, but not comminuting the same.

Preferably the particle size is 50 to 400, especially 50 to 180 micrometres, particularly 50 to 150 micrometres such as 100 micrometres. Particle sizes less than 180 micrometres may be advantageous because it assists the extraction of fibre and may also increase the yields of protein obtained.

Lupin plant and/or seed may be heat treated, for example by steam treatment or other thermal treatment such as contact with heated stances, radiant or microwave heat application or the like, prior to conversion to flour and/or meal. The lupin flour/meal may or may not be treated with an organic solvent such as hexane, ethanol, isopropanol or butane to remove oil prior to further processing via traditional solvent extraction process or super or sub-critical extraction processes.

It may be that flour containing the fat/oil may be particularly advantageous for some applications whilst flour stripped of fat/oil is particularly advantageous for other applications/uses.

Removing the fat can be advantageous in that it minimises the development of a bitter taste or rancid flavours in products on storage, which may occur as a result of chemical changes in the fat/oil over time.

Lupin flour/meal, which may or may not have been heat treated, may be mixed with water and adjusted using any food grade alkali system, such as sodium hydroxide, calcium hydroxide, potassium hydroxide or sodium carbonate to an alkali pH (that is above 7), and preferably between 8.0 and 9.0. Alternatively, water may first be pH adjusted with an alkali system and then added to the lupin flour/meal. The extent and duration of mixing or contact with the alkali conditions are not critical to the invention. Extraction conditions may vary according to the amount of material being extracted, the nature of lupin flour/meal, temperature and vigour of mixing. By way of example, sufficient water may be added to the flour/meal to form a slurry or paste. A mixture of 1 part flour to 2-10 parts water, preferably 4-8 parts water, may advantageously be used. The use of small volumes of water minimises waste production, conserves water usage, and overall increases the production efficiency of the process. After pH adjustment the extraction may be carried out, for example, by gentle mixing at ambient temperature. The time period of the extraction is that which extracts lupin protein from lupin fibre. For example, this may be from 15 minutes to 5 hours, for example 30 minutes to 3 hours such as 1 or 2 hours at ambient temperature (about 20° C.). Shorter time periods may be used at higher process temperatures, for example at 60° C., or longer time periods at lower temperatures.

The resultant alkali water extract (1) may be centrifuged or otherwise separated to produce a fibre pellet (2) and a supernatant (3), which contains the lupin protein. The fibre pellet (2) may be used directly as a plant fibre, or processed in a range of applications as described hereafter. Alternatively, the pellet (2) may be diluted with water and centrifuged to give a purer fibre pellet (4) and another supernatant (5), which may be added to the first supernatant (3). These combined supernatants can then be dried to give lupin protein having a wide range of uses, including use in animal/aquafeed.

The fibrous pellet (2 and/or 4) forms a further aspect of the invention, which is discussed in more detail below.

### The Lupin Protein Extracts

The pH of the protein supernatant (3), or (3) and (5), is then adjusted to between about 3.0 and about 5.0 using any food acid including hydrochloric acid, sulphuric acid or phosphoric acid. This pH range, more preferably between 3.5 and 4.5, gives rise to a lupin protein precipitate which may be collected, for example, by centrifugation to give a lupin protein precipitate (6), designated protein extract or fraction 1 (PF1), and a third protein supernatant (9). The pH of PF1 may be adjusted to between pH 5 and 7, preferably between 5.5 and 6.5, to improve desired functional properties. It may then be washed with ethanol or other solvent if desired, and centrifuged to remove colour and flavour, and reduce microbiological load and obtain purified PF1 (8) and a waste stream (7).

Lupin protein fraction PF1 may be modified using physical, chemical and/or enzymatic means well known in the art, and may be dried by any commercial means including freeze-drying or spay drying.

The third supernatant (9) is then brought to the pH level ranging from 5-7, preferably at 5.7 to 6.3 with any food grade alkali including sodium hydroxide, calcium hydroxide, potassium hydroxide, or sodium carbonate. Calcium hydroxide is preferred. This pH treated supernatant (9) containing finely precipitated lupin protein may be centrifuged to obtain an additional protein isolate (10) and a fourth supernatant (11). This PF2 can be further purified to PF2 (13) and a waste stream (12). Treating the supernatant (11) with a food grade C₂-C₆ solvent such as ethanol or isopropanol (a dehydration step which precipitates protein), precipitates yet another lupin protein designated protein extract or fraction 3 (PF3) which has particularly good functionality (14) and low microbiological load (less than 1000 total plate count). Alternatively, the supernatant (11) may be otherwise dehydrated to give PF3. Dehydration may be carried out by drying, distillation or filtration, precipitation techniques or other techniques. Dehydration conveniently removes impurities. The third protein supernatant (9) may, in a preferable aspect of the processes, be treated with a C₂-C₆ solvent such as ethanol and centrifuged to produce a protein pellet, designated protein fraction 3 (PF3) (14), and a waste stream(15) which contains colour and flavour components, including alkaloids.

Preferably where an organic solvent is employed in the processes of the invention the solvent used is ethanol.

FIG. 1 shows a flow diagram of an embodiment of the invention.

In the process there are 2-3 waste streams represented in FIG. 1 as 7, 12, and 15. The alkaloids in the waste streams may be recovered by chromatography, such as HPLC, or other techniques known in the art for alkaloid recovery. Such recovered alkaloids may be used as crop protectants due to their insecticidal properties.

In accordance with the process embodiments of this invention, up to 85% lupin protein yield may be obtained. The lupin protein recovered may contain from about 50% to about 95% lupin protein. Other components in the fraction may include lipophilic material such as fats, minor amounts of carbohydrates and other lupin components. Additional purification steps can be added if desired.

Lupin protein extract (PF1) generally contains about 68% to about 90% protein, has an emulsion activity of about 50-100%, an emulsion viscosity of about 1000-2000 centipoise, a foam volume expansion of about 100-200% and a foam volume stability of about 0-10%. Other minor components of this protein fraction may include moisture, fat, fibre, small amounts of carbohydrate and ash.

Protein extract (PF2) has a protein content of about 53%, about 100% emulsion activity, an emulsion viscosity of about 3400 centipoise, a foam expansion volume of about 600-710% and a foam volume stability of about 97-100%. This extract also includes some fat, fibre, carbohydrate and ash.

The lupin protein recovered according to the process of this invention, such as PF3, has a very bland flavour and particularly high functionality with respect to whipping and emulsification (emulsification up to 100% as described in Example 3) and whipping up to 700% (as described in Example 3). These properties make tile lupin protein in accordance with this invention particularly suitable as a replacement for dairy, egg and soy proteins in a range of food applications. Examples include, but are not restricted to, baked products, milk replacer, whipped products and toppings, ice cream, soups, pasta and pasta sauces, desserts, ice creams and other dairy products, hot and cold beverages, non dairy whiteners, cream liqueurs, meat based small goods, and other food products. PF1, for example, also has good emulsifying properties (65%) and may be used to replace egg, soy and dairy proteins, for example in a wide range of meat and baked products.

The properties of one or more of the above extracts may be advantageous in that they are not available from alternative materials, for example, the whipping properties of the extract may be greater than those of egg white. Furthermore, it provides an alternative source of replacements for dairy products, which is important given the number of people allergic to dairy products. Additionally, the foams produced from the extracts may have further advantages associated with them that makes them particularly useful for certain applications, for example, the foams seem to have good heat stability properties, which makes them useful in applications such as cappuccinos, hot chocolate or the like.

Alternatively, it allows a heat treatment step in the process without affecting the whipping function for any whipping application.

According to another aspect of the invention there is provided a food product containing a food grade lupin protein, for example as a replacement for dairy, egg, soy or meat protein. Preferably the lupin protein is selected from one or more of lupin protein extracts PF1, PF2 and/or PF3. The protein fractions have high protein content (about 50 to about 85% or more) and a good amino acid profile making them suitable as a nutritional supplement for paediatric, sports and clinical nutrition, for example in sport drinks, energy bars, as a sprinkled or granulated additive to food or drink, or other such uses. PF1, PF2 and PF3 have neutral taste and an off white colour. These are particularly desirable properties, given lupin products are conventionally characterised by a strong unpleasant taste and a yellow colouration limiting their usefulness in food and other applications.

In accordance with another aspect of the invention, there is provided a nutritional supplement containing a food grade lupin protein. Preferably the food grade lupin protein is selected from lupin protein extracts PF1, PF2 and/or PF3.

Lupin protein also finds use as a binder in the paper industry, in adhesives, glues, and resins, for example.

The lupin protein products can also be blended with various additives like polyphosphates or gums, flow control agents, mouth texture agents, and the like. Examples of various prepared food formulations are set out in the examples.

In a further embodiment this invention relates to a lupin fibre component.

### The Lupin Fibre

The fibrous pellet (2 and/or 4) contains soluble fibre. It also has specific properties in that it binds water in the ratio of 7 parts water to 1 part fibre. This makes the fibre particularly useful for applications where water absorption is advantageous, for example, meat products.

This pellet may be treated with acid and/or one or more enzymes such as galactosidases to yield galactose. Galactose so produced may be used in food products, drinks and in other applications. Hydrocolloids and other carbohydrate components may also be recovered.

The alkali insoluble lupin fibrous component recovered in the process of this invention may be used in a range of applications. It may be further treated with peroxide or washed in organic solvent, such as a C₁-C₆ solvent, for example ethanol or isopropanol, preferably ethanol, and centrifuged to produce a cream or off-white fibre. The lupin fibre can be used in a range of food products and animal feeds or further processed using enzymes, such as galactosidases, to produce a galactose rich concentrate for use in sports drinks. This fibre also has industrial application where plant fibres are used, including as a carrier in adhesives, such as corrugating adhesives.

As mentioned above the fibre contains soluble fibre and in a further aspect the invention provides a process of extraction performed on this fibre using a pectin-extraction process as described in Rolin, C., and De Vries, J. (1990) Pectin. Food Gels. Ed. Peter Harris. Elsevier Science, England.) This process comprises mixing the lupin fibre with water, for example 1 part Lupin Fibre with 9 parts water, bringing the pH of the solution down to pH 1-3, for example to pH 2 with HCl, then heating the solution at 60° C.-80° C. for 1-5 hours. Following centrifugation this precipitated fraction can be used without further processing.

Alternatively and preferably, the acidified and heated solution can be separated in two components: a hydrocolloid (SHF1) and a further new fibre (FF1). The solution is centrifuged to separate the soluble fraction, recoverable from the supernatant, from the insoluble fraction, which is the precipitate. The precipitate is washed with 1 part ethanol to 1 part precipitate, then dried and ground to a fine powder (New Fibre Fraction, FF1). The supernatant may be dehydrated, for example using organic solvent, such as C₁-C₆ solvent, for example, ethanol or isopropanol or other dehydration techniques as described above may be used. For example, 1 part ethanol is added to 1 part supernatant and the precipitate collected. The collected precipitate may be washed twice more with 1 part precipitate to 1 part ethanol. The precipitate is then dried and ground to a fine powder (hydrocolloid, SHF1). The ratio of SHF1:FF1 is approximately 1:2 to 2:3.

### Hydrocolloid Fractions (SHF1)

SHF1 has low viscosity and high emulsifying properties. It has similar properties to other non-gelling hydrocolloids in that it does not gel in the presence of calcium ions and forms a white emulsion when mixed with 75:25 water:oil ratio at 0.5-2% concentration. SHF1 has a viscosity of 60 cps at 2% concentration and emulsion activity of 82, while similar non-gelling hydrocolloids have viscosities close to 0 cps and emulsion activities of about 80 at 2% concentration SHF1 is similar to other non-gelling hydrocolloid emulsions having approximately 1.3 micron sized droplets when observed under the microscope. This renders the fraction particularly suitable for use as an emulsifier additive in food stuffs where these properties are required, such as flavours; hot and cold beverages, such as sports beverages, beverages for paediatric and clinical nutrition; and/or food ingredients for soups; dairy products; sauces such as mayonnaise; pastas; desserts; ice creams, confectionery and other dairy/food products. SHF1 forms a hydrocolloid in water, for example with gentle heating (water over room temperature). For example, 10% w/w solutions may be conventionally prepared.

Preferably SHF1 may be used in flavours, sports beverages and hot and cold beverages including beverages for paediatric and clinical nutrition; soups; dairy products; sauces such as mayonnaise and desserts. Advantageously the SHF1 may provide these products with a desirable texture.

### New Fibre Fraction (FF1)

This fraction has reduced water-binding properties and binds water in the ratio of 2 parts water to 1 part fibre. This renders the fraction particularly suitable for use in bakery products, which may remain fresher for longer where this fibre is used. This bland nutritional fibre can also be used in a variety of other food products such as cereals and meat products. In addition the fibre is off-white and needs no further processing to improve colour.

The lupin hydrocolloid (SHF1) and lupin fibre (FF1) are of neutral flavour and off white colour. Like the lupin protein aspects of this invention these characteristics are particularly desirable given the conventional unpleasant taste and strong coloration of lupin material which makes them generally unsuitable for food applications.

The invention will now be further exemplified with reference to the following non-limiting examples.

FIG. 1 shows a process diagram of an embodiment of the process aspect of the invention.

### EXAMPLE 1

500 g of lupin flour is mixed with 2-5 litres of water, stirred in a tank with mild agitation, and the pH raised by addition of sodium hydroxide to a pH between 8 and 10. The mixture is agitated for a period of 30 minutes to 2 hours at ambient temperature (25° C.). The mixture is then centrifuged at 6000 g for 10 minutes to recover a fibre containing pellet.

The fibre containing pellet is washed with 700 ml of water and recentrifuged. The fibrous pellet is then dried and reserved for later processing for recovery of sugars, pectins and other carbohydrate components.

The water wash is added to the first supernatant, and the pH adjusted to between pH 3 to 5 with acid (hydrochloric or phosphoric acid). The resulting acidified composition was centrifuged at 6000 g, and a protein fraction (PF1) recovered. PF1 is adjusted to 5 to 6.5 with alkali, ethanol washed, and dried to remove ethanol, for example by spray drying or rotary evaporation, to give a proteinaceous powder.

The resulting supernatant is adjusted to pH 5 to 7 with potassium hydroxide, causing a flocculated protein isolate to precipitate. This isolate (PF2) may be recovered by centrifugation for subsequent use in various applications.

The remaining supernatant is treated with 1300 ml of ethanol to produce a protein precipitated fraction PF3.

The protein fraction 1 and protein fraction 2 and isolate were analysed and were found to compose the following:

| | Protein | Protein | Isolate |
|---|---|---|---|
| | fraction 1 | fraction 3 | (PF2) |
| Protein wt (g) | 93 | 19.75 | 22.58 |
| Protein yield (%) | 55.02 | 11.6 | 13.3 |
| Emulsification activity (%) | 53-55 | 100 | 55-59 |
| Emulsion viscosity (cp) | 1000-2000 | 3400 | 2500 |
| Foam volume expansion | 100-200 | 600-710 | 10 |
| (%) | | | |
| Foam volume stability (%) | 0-10 | 97-100 | 0 |
| Protein (%) | 68.2 | 53.6 | 87.5 |
| Moisture (%) | 3.4 | 5 | 4.6 |
| Fat (%) | 16.3 | 1 | 2.9 |
| Total fibre (%) | 5.6 | 18.2 | 1.2 |
| CHO (%) | 2 | 6 | 3.7 |
| Ash (%) | 9.3 | 15.8 | 5.6 |

### EXAMPLE 2

Application of the lupin protein of Example 1.

Coffee Whitener

| Ingredients | % |
|---|---|
| Maltodextrin | 36 |
| Water | 39.6 |
| Lupin protein extract PF3 | 1.8 |
| Fat | 21 |
| Emulsifier | 0.6 |
| Dipotassium phosphate | 1 |

Procedure:

Premix water protein and dipotassium phosphate and heat to 50° C.

Add maltodextrin and heat to 65° C.

Add fat and emulsifier and heat to 85° C.

Emulsify using twin screw homogeniser and spray dry

Continental Frankfurt

| Ingredients | % |
|---|---|
| Mutton (90% lean) | 15 |
| Pork trimmings (50% lean:50% fat) | 36.44 |
| Pork fat | 11 |
| Ice water | 27.3 |
| Potato starch | 4 |
| Lupin protein isolate, or lupin protein extract PF1 | 2.8 |
| Salt | 2 |
| Frankfurt flavour concentrate | 0.3 |
| Smoke flavour | 0.5 |
| Sodium tripolyphosphate | 0.5 |
| Sodium erythorbate | 0.1 |
| Sodium nitrite | 0.02 |
| Sodium metabisulphite | 0.04 |

Procedure
1. Mince chop together approx 30% ice plus lupin protein isolate.
2. Add fat and remaining ice, water-chop to form a smooth creamy fat emulsion (approx 60 sec).
3. Add meat, continue chopping (approx 30-60 sec).
4. Add salt, phosphate, sodium nitrite, sodium erythorbate and cut until temp 5° C.
5. Add seasoning and chop until temp reaches 10° C.
6. Add starch and cut until temp 12° C.
7. Fill mixture into casings.
8. Fully immerse frankfurts in 75° C. water cooker and heat to an internal temperature of 72° C.
9. Cool in ice water at 4° C. Cool to internal temperature of 10° C.
10. Chill further in blast chiller.

Meat Product

| Ingredients | % |
|---|---|
| Meat | 66-68 |
| Ice water | 28-30 |
| Salt | 2-3 |
| Lupin protein extract PF1, PF2 or PF3 | 2-3 |
| Phosphates | 0.3-0.5 |
| Sodium nitrite | 0.025 |
| Sodium erythorbate | 0.1 |
| Potato starch | 2.0-4.0 |

Procedure:
1. Dissolve phosphate, sugar, salt and cuing agent in water.
2. Add protein extracts prior to use.
3. pH should be 6-6.5.
4. Section meat as desired.
5. Inject brine into meat with multineedle injector.
6. Stuff in casing and process.

Performance nutrition drink

| | |
|---|---|
| Lupin protein (PF1/PF2/PF3) | 20 g |
| Maltodextrin | 15 g |
| Fat | 1 g |
| Carbohydrates | 4 g |
| Sugars | 3 g |
| Vitamins and minerals | as required |
| Artificial flavours | as required |
| Artificial sweeteners | as required |

Preparation

Blend ingredients to give approximately 45 g or one serve of the protein powder blend. Prepare the performance nutrition drink by blending 45 g powder with 100 mls water, milk or fruit juice.

Nutritious Protein Drink (300) mls

| | |
|---|---|
| Water | 300 mls |
| Lupin protein (PF1/PF2/PF3) | 15 g |
| Fat | 1.5 g |
| Carbohydrates | 27 g |
| Sugars | 23 g |
| Dietary fibre | 1.1 g |
| Vitamins and minerals | as required |
| Artificial flavours | as required |
| Artificial sweeteners | as required |

Procedure

Mix water and dry ingredients using a homogeniser.

1 batch as above will produce 4×700 g loaves.

### EXAMPLE 3

Performance tests on lupin protein emulsification and foaming.

1. Emulsification Test
1. Take 7 g of lupin protein.
2. Add 100 mls of water.
3. Mix in the omni mixer at 5000 rpm for 10 seconds.
4. Add 100 mls of canola oil and mix for 1 minute.
5. Measure the viscosity in the Brookfield viscometer with spindle 3 at 5 rpm
6. Take 40 g of the emulsion.
7. Centrifuge at 3000× g for 10 minutes.
8. Measure the height of the emulsified layer (A) and the total height in the tube (B).
9. Emulsifying activity is measured as A/B*100.

2. Whipping Test
1. Take 5 g of sample as is
2. Add 100 mls of water
3. Whip for 5 min in Kenwood mixer.
4. Pour the contents in a 1000 ml, clear measuring cylinder.
5. Measure the total height including the foam.
6. Let the foam stand for 30 minutes.
7. Measure the volume of foam alone and the amount of liquid drained at the bottom of the foam.

Foam Volume expansion is calculated as:

$$\frac{Total volume - initial volume}{Initial volume} \times 100.$$

### EXAMPLE 4

500 g of Lupin fibre is mixed with 3-5 litres of water, stirred with mild agitation, and the pH adjusted to pH 1-3 with hydrochloric acid. The mixture is agitated at 60-80° C. for 1-5 hours and then centrifuged at 3000 rpm for 10 minutes.

The precipitate is washed with 1:1 ethanol and then dried and ground to a fine powder FF1).

The supernatant is mixed with 1:1 ethanol and allowed to stand at room temperature for 30 minutes to 1 hour to precipitate the soluble fibre fraction.

The precipitate is recovered by centrifugation and washed twice with 1:1 ethanol. The washed precipitate is then dried and ground to a fine powder (SHF1).

The soluble fraction (SHF1) and fibre fraction (FF1) were analysed and were found to compose of the following:

| | Hydrocolloid | Fibre |
|---|---|---|
| | fraction | fraction |
| | (SHF) | (FF1) |
| Moisture (%) | 7.6 | 4.5 |
| Soluble fibre (%) | 68.8 | 25.4 |
| Insoluble fibre (%) | 1.0 | 55.3 |
| Protein (%) | 2.9 | 8.0 |
| Fat (%) | 1.6 | 3.1 |
| Total CHO (% | 17.8 | 3.1 |
| Ash (%) | 0.4 | 0.6 |
| Emulsification activity (%) | 78-82 | NA |
| Emulsion viscosity (cps) | 0-60 | NA |
| Water holding capacity | NA | 2 |

### EXAMPLE 5

Application of the hydrocolloid fraction and fibre fraction of Example 4.

Tropical Iced Drink

| Ingredients | % |
|---|---|
| low-fat milk | 20.0 |
| pineapple juice | 28.0 |
| orange juice | 23.0 |
| coconut extract | 0.6 |
| hydrocolloid (SHF1) | 4.0 |
| sugar | 1.4 |
| flaked ice (add last) | 23.0 |
| | 100.0 |

Procedure:
1. Warm the pineapple juice
2. Blend the soluble fibre into the warmed pineapple juice
3. Blend together with other ingredients except ice
4. Lastly blended in the flaked ice

High Fibre Bread

| Ingredients | (g) |
|---|---|
| Flour | 1860 |
| Salt | 36 |
| Water @ 25 C. | 1400 |
| Yeast dry | 30 |
| Gluten | 40 |
| Oil | 20 |
| Bread improver | 20 |
| Bread softener | 20 |
| FF1 | 140 |

Preparation Conditions:

Spiral mixer

| | |
|---|---|
| Total mix time | 1 min slow 8 min fast |
| Final dough temp | 30-31° C. |
| Dough scale wt | 825 g |
| Bake wt | 700 g |
| Tins | 193 |
| Intermediate Proof | 8 mins |
| Final Proof | 65-70 mins |
| Bake Temp/Time | 210° C./30 mins |

Throughout this specification and the claims which follow, unless the context requires otherwise, the word “comprise”, or variations such as “comprises” or “comprising”, will be understood to imply the inclusion of a stated integer or step or group of integers or steps but not the exclusion of any other integer or step or group of integers or steps.

The reference to any prior art in this specification is not, and should not be taken as an acknowledgment or any form of suggestion that that prior art forms part of the common general knowledge in Australia.

1. A process for the production of lupin extracts from lupins, comprising:
(a) extracting lupin meal or flour with water at alkaline pH;
(b) separating an alkali soluble lupin protein containing component from an alkali insoluble fibrous component;
(c) adjusting the pH of the protein component with acid to a pH between 3-5.0 to precipitate a food grade lupin protein extract (PF1), from an acid soluble lupin protein containing component, collecting said precipitated food grade lupin protein extract (PF1), adjusting the pH of the extract to pH 5-6.5 and thereafter drying the extract to give a proteinaceous extract (PF1); and optionally,
(d) dehydrating the acid soluble lupin protein containing component to give a second food grade lupin protein extract (PF3); or
(e) raising the pH of the acid soluble lupin protein component to pH 5-7, and optionally recovering a lupin protein isolate (PF2), followed by dehydrating the soluble lupin protein component to give a third food grade lupin protein fraction (PF3).

2. A process according to claim 1 wherein lupin meal or flour is mixed with water at a ratio of lupin flour or meal to water of 1:2-10 on a w/w basis.

3. A process according to claim 2 wherein lupin meal or flour is mixed with water at a ratio of lupin flour or meal to water of 1:4-8 on a w/w basis.

4. A process according to claim 1 wherein said lupin meal or flour is extracted with water at an alkaline pH of from about pH 7-pH 9.

5. A process according to claim 1 wherein the acid soluble lupin protein component of step (d) is dehydrated by precipitation with a C₁-C₆ food grade organic solvent and the precipitated lupin protein extract (PF3) recovered.

6. A process according to claim 1 wherein the acid soluble lupin protein component of step (d) is dehydrated and purified by evaporation, distillation or filtration.

7. A process according to claim 1 wherein the acid soluble lupin protein component of step (e) is dehydrated by precipitation with a C₁-C₆ food grade organic solvent and the precipitated lupin protein extract (PF3) recovered.

8. A process according to claim 1 wherein the acid soluble lupin protein component of step (e) is dehydrated by evaporation, distillation or filtration.

9. A process according to claim 1, which comprises said process steps (a) through (c), (a) through (d), or (a) to (c) and (e).

10. A process according to claim 1 wherein said food grade organic solvent is selected from ethanol and propanol.

11. A process according to claim 1 wherein one or more lupin protein extracts PF1, PF2 and PF3 are recovered.

12. A process according to claim 1 wherein a lupin protein isolate is recovered.

13. A process according to claim 1 which produces lupin protein extracts and isolate having an off white colour and neutral-taste.

14. A process according to claim 1 for the production of a food grade lupin protein extract.

15. A food product containing a lupin protein extract produced according to the process of claim 1.

16. A food product according to claim 15 wherein said lupin protein is a replacement for dairy, egg, soy or meat protein in the food product.

17. A nutritional supplement containing a lupin protein extract produced according to the process of claim 1.

18. A nutritional supplement according to claim 17 containing lupin protein extract PF1, PF2 or PF3.

19. A paper coating composition containing a lupin protein extract produced according to the process of claim 1.

20. A paper coating according to claim 19 wherein said lupin protein extract is selected from PF1, PF2 and PF3.

21. A feed ingredient containing a lupin protein extract produced according to the process of claim 1.

22. A feed ingredient according to claim 21 wherein said lupin protein extract is selected from PF1, PF2 and PF3.

23. A food product containing a lupin protein isolate produced according to the process of claim 1.

24. A food product according to claim 19 wherein said lupin protein isolate is a replacement for dairy, egg, soy or meat protein in said food product.

25. A process according to claim 1 wherein said alkali insoluble fibrous component is recovered.

26. A process according to claim 21 wherein said alkali insoluble fibrous component is washed in water and subsequently treated with acid and/or one or more enzymes to produce galactose.

27. A process for the production of lupin fibre extracts from lupins, comprising:
(a) extracting lupin meal or flour with water at alkaline pH;
(b) separating an alkali soluble lupin protein containing component from an alkali insoluble fibrous component; and
(c) mixing the fibrous component with water at pH 1-3, heating for 1-5 hours at a temperature of 60° C.-80° C., and thereafter separating an insoluble precipitate (FF1) from a hydrocolloid (SHF1).

28. A product according to claim 25, wherein the product is SHF1 or FF1.
